(19) United States
(12) Patent Application Publication
(10) Pub. No.: US 2025/0258524 A1
(43) Pub. Date: Aug. 14, 2025

(54) Electronic Bookmark Device

(71) Applicant: Anthony Gibson, Laplace, LA (US)

(72) Inventor: Anthony Gibson, Laplace, LA (US)

(21) Appl. No.: 18/914,424

(22) Filed: Oct. 14, 2024

Related U.S. Application Data
(60) Provisional application No. 63/551,274, filed on Feb. 8, 2024.

(51) Int. Cl. G06F 1/16

(52) U.S. Cl. CPC G06F 1/1696; G06F 1/1637; G06F 1/169

(57) ABSTRACT

An electronic bookmark device is disclosed which comprises a housing component that enables the user to scan, use verbal commands, or manually input whatever information they wish to know about a certain text. Artificial intelligence is used to process the information being scanned by the device. Further, word information can be broken down with this device through an etymology function that can accommodate any academic curriculum or long extensive contract. Thus, the device summarizes information in a way that is quick and easy to understand. Further, there may also be a microphone that receives information through voice recognition, an internal digital calculator if numbers or equations are being scanned, as well as a touchscreen and stylus on the front of the bookmark.

### CROSS-REFERENCE TO RELATED APPLICATION

The present application claims priority to, and the benefit of, U.S. Provisional Application No. 63/551,274, which was filed on Feb. 8, 2024, and is incorporated herein by reference in its entirety.

### FIELD OF THE INVENTION

The present invention relates generally to the field of electronic bookmark devices. More specifically, the present invention relates to a bookmark that enables the user to virtually interact with the specific text. Accordingly, the present disclosure makes specific reference thereto. Nonetheless, it is to be appreciated that aspects of the present invention are also equally applicable to other like applications, devices and methods of manufacture.

### BACKGROUND

By way of background, this invention relates to improvements in electronic bookmark devices. Generally, individuals may lose interest in reading due to a lack of comprehension of what they are reading. They can lose their place when stopping to look up certain words or phrases which makes them unlikely to return to the text. Accordingly, individuals tend to dislike concepts or information they cannot understand which can make reading difficult.

Accordingly, a bookmark constructed in accordance with the invention makes reading any subject easier to understand. Further, it is often necessary for people to define words or concepts while reading a book or contract. Additionally, the device would be ideal to keep your place in the text, while also looking up the necessary information. Accordingly, a regular bookmark is typically used in such situations and users must move the bookmark to research information, causing their place in the book to be lost.

Accordingly, there is a demand for an improved electronic bookmark device that allows users to scan text, use voice commands, and manually input researched information into the text. More particularly, there is a demand for an electronic bookmark device that makes reading easier and more enjoyable to users.

Therefore, there exists a long felt need in the art for an electronic bookmark device that provides a bookmark with smart capabilities to encourage individuals to read more often. There is also a long felt need in the art for an electronic bookmark device that assists individuals in understanding and comprehending what they are reading to maximize enjoyment. Further, there is a long felt need in the art for an electronic bookmark device that features an Al function that allows users to look up information about any word, sentence, or paragraph in the text they are reading. Moreover, there is a long felt need in the art for a device that utilizes scanning technology, voice commands, and manual input to research content. Further, there is a long felt need in the art for an electronic bookmark device that makes reading easier and therefore more enjoyable to readers of all ages and skill levels. Finally, there is a long felt need in the art for an electronic bookmark device that includes a solar power option to allow the device to consistently supply power to the internal battery.

The subject matter disclosed and claimed herein, in one embodiment thereof, comprises an electronic bookmark device. The device is an electronic bookmark designed to bring the enjoyment back to reading. The electronic bookmark device comprises a housing component that enables the user to scan, use verbal commands, or manually input whatever information they wish to know about a certain text. Artificial intelligence is used to process the information being scanned by the device. Further, word information can be broken down with this device through an etymology function that can accommodate any academic curriculum or long extensive contract. Thus, the device summarizes information in a way that is quick and easy to understand. Further, there may also be a background, soundproof wireless microphone that receives information through voice recognition without any background interruptions. An internal digital calculator may also be used if numbers or equations are being scanned, as well as a touchscreen and stylus on the front of the bookmark.

In this manner, the electronic bookmark device of the present invention accomplishes all of the forgoing objectives and provides users with a bookmark with smart capabilities to encourage individuals to read more often. The device is an electronic bookmark. The device can comprise a touchscreen and stylus.

### SUMMARY OF THE INVENTION

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises an electronic bookmark device. The device is an electronic bookmark designed to bring the enjoyment back to reading. The electronic bookmark device comprises a housing component that enables the user to scan, use verbal commands, or manually input whatever information they wish to know about a certain text. Artificial intelligence is used to process the information being scanned by the device. Thus, the device summarizes information in a way that is quick and easy to understand.

In one embodiment, the smart bookmark device can be manufactured in a variety of configurations and shapes. The below embodiments describe the invention configured in an elongated rectangular shape, but any other suitable shapes and sizes can be adapted depending on the needs and/or wants of a user. Further, the smart bookmark device can be configured in any suitable shape and size, as long as the device is shaped and sized to retain a processor and memory for support and for executing various functions, such as enabling a user to scan, use verbal commands, or manually input information, etc.

In one embodiment, the smart bookmark device comprises a housing component. Typically, the housing component comprises a front surface, a bottom surface, opposing top and bottom ends, and opposing right and left sides. Further, the housing component includes a display module with a display screen (positioned on the front surface) and a plurality of buttons. The display screen is operable to generate a display of a specific part of text, a definition, notes, etc. The buttons include an on/off button, which is operable to be engaged to turn the device on/off, or to change display modes. Specifically, the on/off button allows the user to direct the processor to vary the mode of operation of the device. Further, the housing component can support the viewable display screen of the display module and a plurality of buttons. The display screen can generate high resolution output. The exemplary display screen can be an LCD screen, but other display technologies can be used in alternative embodiments of the invention. The exemplary display screen can display alphanumeric images, as well as, graphic symbols and different colors.

In one embodiment, the display screen is a touchscreen and allows a user to highlight text, take notes, scroll through functions, etc., using their fingers.

In another embodiment, the housing component includes a stylus. The stylus can be utilized with the touchscreen to access information, highlight text, take notes, etc. The stylus can be any suitable shape and size and typically resembles a conventional stylus, as is known in the art.

In one embodiment, the housing component comprises a wedge shape on an opposing left side. The wedge shape depicts a sloping end and allows a user to fit that side into the spine of the book. The wedge shape allows the device to be secured within a book, during use.

In one embodiment, the housing component comprises electronic circuitry including one or more processors, memory, and input/output components. In one embodiment, the processor, may be a CPU, a microprocessor, a controller, or any other type of computing device that may process programs and/or instructions, and which may control the other electrical components within the smart bookmark device. The processor may also include a transmitter/receiver (i.e., input/output component). The memory in different embodiments of the invention could be chosen to be large enough to also store data, such as text data, highlighted notes, and/or personal information, etc. Other circuits of varying sizes and functionalities can be applied in other embodiments of the invention. The electronic circuitry and components (i.e., processor and memory) provide the device with smart capabilities and functions, such as enabling the user to scan the text with the device, use verbal commands, or manually input whatever information they wish to know about a specific text, paragraph, word, sentence, etc. Further, the processor comprises Artificial Intelligence (AI), which helps process information when scanned by the bookmark device. The AI communicates with the processors, memory and input/output components to process information and output definitions and other requested information. In another embodiment, the processor comprises an etymology function, as well as, legal dictionaries, medical dictionaries, or other academic curriculum, etc., which can be accessed by the processors and input/output components. Thus, the device takes the complication and time out of long extensive contracts, whether a user is buying a house, car, promissory note, etc. The device summarizes the text in a way that is quick and easy to understand.

In one embodiment, the smart bookmark device comprises wireless communication capabilities and may be connected to the internet. Further, the smart bookmark device may perform any type of wireless communication, including, but not limited to, WIFI, BLUETOOTH, RFID, NFC, etc. The smart bookmark device further includes a wireless communication module and additional sensors which would allow the smart bookmark device to communicate with the internet or outside databases of information when performing functionalities, such as etymology, AI, and other academic curriculums, etc. Embodiments of the invention may also incorporate a USB port for communication. In this embodiment, the memory of the device does not have to store the AI or the etymology functionality, or any other electronic capabilities and functionalities, but these can be accessed via the wireless communication of the device with external resources or databases containing such functionalities.

In one embodiment, the processor, the display screen, the memory, the input/output components, and other electrically-powered components of the device can be powered by a battery operable to supply direct current. Such a battery could be rechargeable. In alternative embodiments, a solar panel could be incorporated to provide power.

In other embodiments of the invention, the display module can also include circuitry, programming, and any other necessary components to house an internal digital calculator. The digital calculator is utilized if numbers and/or equations are scanned, instead of text. The digital calculator functions as conventional calculator, as is known in the art.

In one embodiment, the display module can also include circuitry, programming, and any other necessary components to house a background, soundproof wireless microphone that can receive information via voice recognition without background interruption. Thus, as users are reading the text, they can look up words, sentences, or paragraphs, via voice commands issued into the wireless microphone. The wireless microphone can be a conventional microphone that eliminates/cancels background noise during use.

In other embodiments of the invention, the display module can also include circuitry, programming, a speaker, and any other necessary components to generate audible sounds. For example, the display module could be operable to operate in an alarm mode, such that the user could set an audible alarm to go off at a desired time. Such alarms could also be communicated to the user by vibration in other embodiments of the invention.

In one embodiment, the design of the invention is intended to minimize interference while reading a text, book, contract, etc., and to permit efficient and time-saving research, reading, note taking, comprehension, etc.

In one embodiment, the smart bookmark device is made of a lightweight, durable material such as plastic, rubber, or the like and manufactured through common molding processes. Specifically, the device can be manufactured from heat-scalable plastic or polymers, such as polypropylene or acrylonitrile-butadiene-styrene (ABS), or any other suitable material as is known in the art, such as but not limited to, acrylic, polycarbonate, polyethylene, polyethylene terephthalate, polyvinyl chloride, polystyrene, etc. Generally, the smart bookmark device is also manufactured from a material that is water resistant or waterproof, or comprises a coating that is water resistant or waterproof. Further, the device is made of antibacterial or antimicrobial material or comprises a coating that is antibacterial or antimicrobial.

In one embodiment, the device can be molded in various colors and patterns to match existing decor, based upon a user's preference.

In yet another embodiment, the smart bookmark device comprises a plurality of indicia.

In yet another embodiment, a method of assisting readers while reading a book is disclosed. The method includes the steps of providing a smart bookmark device comprising a housing component with a microphone, a digital calculator, a touchscreen and a stylus. The method also comprises utilizing AI and etymology functions to scan text and lookup information. Further, the method comprises receiving information via voice commands on the microphone. The method also comprises utilizing the digital calculator when numbers or equations are scanned. Finally, the method comprises highlighting information via the touchscreen and stylus to save as notes.

Numerous benefits and advantages of this invention will become apparent to those skilled in the art to which it pertains, upon reading and understanding the following detailed specification.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of one embodiment of the smart bookmark device of the present invention showing the device scanning texts in accordance with the disclosed architecture;

FIG. 2 illustrates a perspective view of one embodiment of the smart bookmark device of the present invention showing the housing of the device in accordance with the disclosed architecture;

FIG. 3 illustrates a perspective view of one embodiment of the smart bookmark device of the present invention showing the wedge end which fits into a book spine in accordance with the disclosed architecture;

FIG. 4 illustrates a perspective view of one embodiment of the smart bookmark device of the present invention showing the stylus and touchscreen in accordance with the disclosed architecture;

FIG. 5 illustrates a perspective view of one embodiment of the smart bookmark device of the present invention showing the device defining a word in accordance with the disclosed architecture; and

FIG. 6 illustrates a flowchart showing the method of assisting readers while reading a book in accordance with the disclosed architecture.

### DETAILED DESCRIPTION OF THE PRESENT INVENTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there is a long felt need in the art for an electronic bookmark device that provides a bookmark with smart capabilities to encourage individuals to read more often. There is also a long felt need in the art for an electronic bookmark device that assists individuals in understanding and comprehending what they are reading to maximize enjoyment. Further, there is a long felt need in the art for an electronic bookmark device that features an Al function that allows users to look up information about any word, sentence, or paragraph in the text they are reading. Moreover, there is a long felt need in the art for a device that utilizes scanning technology, voice commands, and manual input to research content. Further, there is a long felt need in the art for an electronic bookmark device that makes reading easier and therefore more enjoyable to readers of all ages and skill levels. Finally, there is a long felt need in the art for an electronic bookmark device that includes a solar power option to allow the device to consistently supply power to the internal battery.

The present invention, in one exemplary embodiment, is a novel electronic bookmark device. The electronic bookmark device comprises a housing component that enables the user to scan, use verbal commands, or manually input whatever information they wish to know about a certain text. Artificial intelligence is used to process the information being scanned by the device. Further, word information can be broken down with this device through an etymology function that can accommodate any academic curriculum or long extensive contract. Further, there may also be a background, soundproof wireless microphone that receives information through voice recognition without any background interruptions. An internal digital calculator may also be used if numbers or equations are being scanned, as well as a touchscreen and stylus on the front of the bookmark. The present invention also includes a novel method of assisting readers while reading a book. The method includes the steps of providing a smart bookmark device comprising a housing component with a microphone, a digital calculator, a touchscreen and a stylus. The method also comprises utilizing AI and etymology functions to scan text and lookup information. Further, the method comprises receiving information via voice commands on the microphone. The method also comprises utilizing the digital calculator when numbers or equations are scanned. Finally, the method comprises highlighting information via the touchscreen and stylus to save as notes.

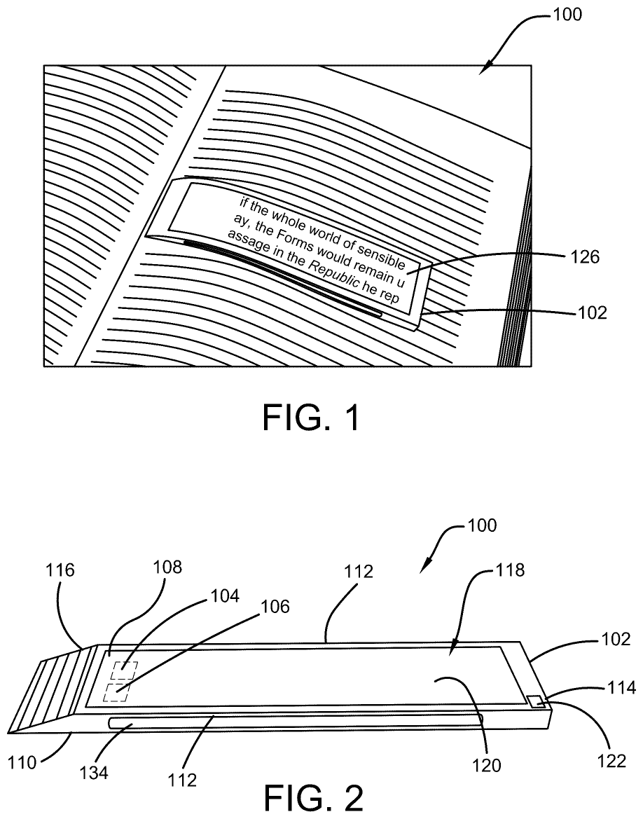

Referring initially to the drawings, FIG. 1 illustrates a perspective view of one embodiment of the smart bookmark device 100 of the present invention. In the present embodiment, the smart bookmark device 100 is an improved smart bookmark device 100 that provides a user with an electronic bookmark for assisting a reader when reading and researching content. Specifically, the smart bookmark device 100 comprises a housing component 102 that enables the user to scan, use verbal commands, or manually input whatever information they wish to know about a certain text. Artificial intelligence is used to process the information being scanned by the device 100. Thus, the device 100 summarizes information in a way that is quick and easy to understand.

Generally, the smart bookmark device 100 can be manufactured in a variety of configurations and shapes. The below embodiments describe the invention configured in an elongated rectangular shape, but any other suitable shapes and sizes can be adapted depending on the needs and/or wants of a user. Further, the smart bookmark device 100 can be configured in any suitable shape and size, as long as the device 100 is shaped and sized to retain a processor 104 and memory 106 for support and for executing various functions, such as enabling a user to scan, use verbal commands, or manually input information, etc.

Further, the smart bookmark device 100 comprises a housing component 102. Typically, the housing component 102 comprises a front surface 108, a bottom surface 110, opposing top and bottom ends 112, and opposing right 114 and left 116 sides. Further, the housing component 102 includes a display module 118 with a display screen 120 (positioned on the front surface 108) and a plurality of buttons 122. The display screen 120 is operable to generate a display of a specific part of text 126, a definition, notes, etc. The buttons 122 include an on/off button, which is operable to be engaged to turn the device on/off 122, or to change display modes. Specifically, the on/off button 122 allows the user to direct the processor 104 to vary the mode of operation of the device 100. Further, the housing component 102 can support the viewable display screen 120 of the display module 118 and a plurality of buttons 122. The display screen 120 can generate high resolution output. The exemplary display screen 120 can be an LCD screen, but other display technologies can be used in alternative embodiments of the invention. The exemplary display screen 120 can display alphanumeric images, as well as, graphic symbols and different colors.

As shown in FIG. 2, the housing component 102 comprises electronic circuitry including one or more processors 104, memory 106, and input/output components 124. In one embodiment, the processor 104, may be a CPU, a microprocessor, a controller, or any other type of computing device that may process programs and/or instructions, and which may control the other electrical components within the smart bookmark device 100. The processor 104 may also include a transmitter/receiver (i.e., input/output component 124). The memory 106 in different embodiments of the invention could be chosen to be large enough to also store data, such as text data, highlighted notes, and/or personal information, etc. Other circuits of varying sizes and functionalities can be applied in other embodiments of the invention. The electronic circuitry and components (i.e., processor 104 and memory 106) provide the device 100 with smart capabilities and functions, such as enabling the user to scan the text 126 with the device 100, use verbal commands, or manually input whatever information they wish to know about a specific text 126, paragraph, word, sentence, etc. Further, the processor 104 comprises Artificial Intelligence (AI), which helps process information when scanned by the bookmark device 100. The AI communicates with the processors 104, memory 106 and input/output components 124 to process information and output definitions and other requested information. In another embodiment, the processor 104 comprises an etymology function, as well as, legal dictionaries, medical dictionaries, or other academic curriculum, etc., which can be accessed by the processors 104 and input/output components 124. Thus, the device 100 takes the complication and time out of long extensive contracts, whether a user is buying a house, car, promissory note, etc. The device 100 summarizes the text 126 in a way that is quick and easy to understand.

In one embodiment, the smart bookmark device 100 comprises wireless communication capabilities and may be connected to the internet. Further, the smart bookmark device 100 may perform any type of wireless communication, including, but not limited to, WIFI, BLUETOOTH, RFID, NFC, etc. The smart bookmark device 100 further includes a wireless communication module 128 and additional sensors which would allow the smart bookmark device 100 to communicate with the internet or outside databases of information when performing functionalities, such as etymology, AI, and other academic curriculums, etc. Embodiments of the invention may also incorporate a USB port 130 for communication. In this embodiment, the memory 106 of the device 100 does not have to store the AI or the etymology functionality, or any other electronic capabilities and functionalities, but these can be accessed via the wireless communication module 128 of the device 100 with external resources or databases containing such functionalities.

Further, the processor 104, the display screen 120, the memory 106, the input/output components 124, and other electrically-powered components of the device 100 can be powered by a battery 132 operable to supply direct current. Such a battery 132 could be rechargeable. In alternative embodiments, a solar panel 134 could be incorporated to provide power.

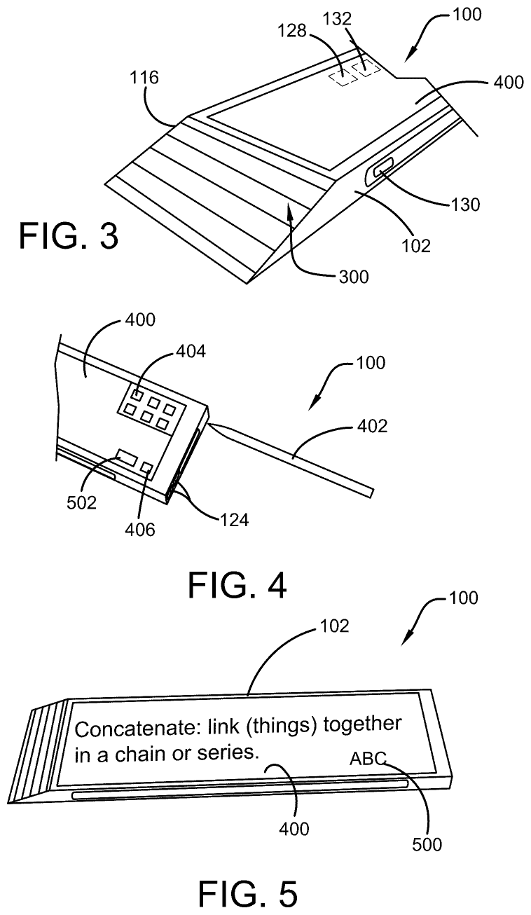

As shown in FIG. 3, the housing component 102 comprises a wedge shape 300 on an opposing left side 116. The wedge shape 300 depicts a sloping end and allows a user to fit that side 116 into the spine of the book. The wedge shape 300 allows the device 100 to be secured within a book, during use.

As shown in FIG. 4, the display screen 120 is a touchscreen 400 and allows a user to highlight text 126, take notes, scroll through functions, etc., using their fingers.

Further, the housing component 102 includes a stylus 402. The stylus 402 can be utilized with the touchscreen 400 to access information, highlight text 126, take notes, etc. The stylus 402 can be any suitable shape and size and typically resembles a conventional stylus 402, as is known in the art.

In one embodiments of the invention, the display module 118 can also include circuitry, programming, and any other necessary components to house an internal digital calculator 404. The digital calculator 404 is utilized if numbers and/or equations are scanned, instead of text 126. The digital calculator 404 functions as conventional calculator, as is known in the art.

In one embodiment, the display module 118 can also include circuitry, programming, and any other necessary components to house a background, soundproof wireless microphone 406 that can receive information via voice recognition without background interruption. Thus, as users are reading the text 126, they can look up words, sentences, or paragraphs, via voice commands issued into the wireless microphone 406. The wireless microphone 406 can be a conventional microphone that eliminates/cancels background noise during use.

As shown in FIG. 5, the display module 118 can also include circuitry, programming, a speaker 502, and any other necessary components to generate audible sounds. For example, the display module 118 could be operable to operate in an alarm mode, such that the user could set an audible alarm to go off at a desired time. Such alarms could also be communicated to the user by vibration in other embodiments of the invention.

In one embodiment, the design of the invention is intended to minimize interference while reading a text, book, contract, etc., and to permit efficient and time-saving research, reading, note taking, comprehension, etc.

In another embodiment, the smart bookmark device 100 is made of a lightweight, durable material such as plastic, rubber, or the like and manufactured through common molding processes. Specifically, the device 100 can be manufactured from heat-scalable plastic or polymers, such as polypropylene or acrylonitrile-butadiene-styrene (ABS), or any other suitable material as is known in the art, such as but not limited to, acrylic, polycarbonate, polyethylene, polyethylene terephthalate, polyvinyl chloride, polystyrene, etc. Generally, the smart bookmark device 100 is also manufactured from a material that is water resistant or waterproof, or comprises a coating that is water resistant or waterproof. Further, the device 100 is made of antibacterial or antimicrobial material or comprises a coating that is antibacterial or antimicrobial.

In one embodiment, the device 100 can be molded in various colors and patterns to match existing decor, based upon a user's preference.

In yet another embodiment, the smart bookmark device 100 comprises a plurality of indicia 500. The housing component 102 of the device 100 may include advertising, a trademark, or other letters, designs, or characters, printed, painted, stamped, or integrated into the housing component 102, or any other indicia 500 as is known in the art. Specifically, any suitable indicia 500 as is known in the art can be included, such as but not limited to, patterns, logos, emblems, images, symbols, designs, letters, words, characters, animals, advertisements, brands, etc., that may or may not be bookmark, text, or brand related.

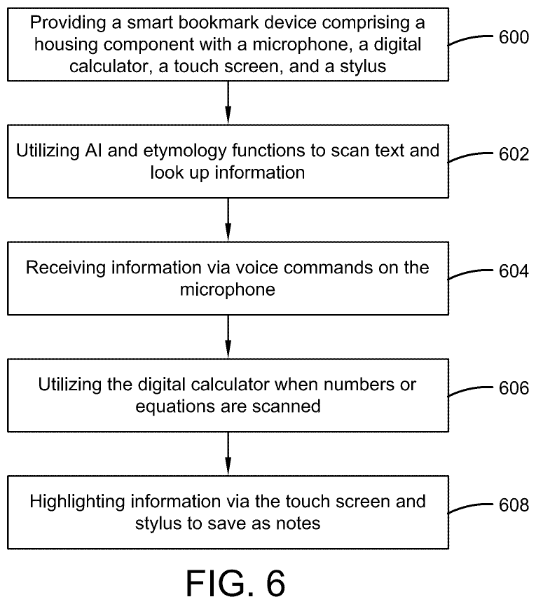

FIG. 6 illustrates a flowchart of the method of assisting readers while reading a book. The method includes the steps of at 600, providing a smart bookmark device comprising a housing component with a microphone, a digital calculator, a touchscreen and a stylus. The method also comprises at 602, utilizing AI and etymology functions to scan text and lookup information. Further, the method comprises at 604, receiving information via voice commands on the microphone. The method also comprises at 606, utilizing the digital calculator when numbers or equations are scanned. Finally, the method comprises at 608, highlighting information via the touchscreen and stylus to save as notes.

It is also contemplated that the device may also include the following functionalities: (a) record/interpret; (b) summarize/simplify; (c) synonym/antonym; (d) encyclopedia; (e) grammar; (f) automatically pick up subject by calibrating context of information fed to the device; (g) record lectures, speeches, sermons, etc. via television, radio or in person (Note: when the Bluetooth mic is not engaged, the device will be able to engage with background communication); (h) recorded input will automatically be translated into text; (i) real time language interpretation (e.g., whether scanned, recorded, etc., the device will automatically translate into text script) in the majority of, if not all, foreign languages; (j) uses artificial intelligence to process the information.

Certain terms are used throughout the following description and claims to refer to particular features or components. As one skilled in the art will appreciate, different users may refer to the same feature or component by different names. This document does not intend to distinguish between components or features that differ in name but not structure or function. As used herein “smart bookmark device”, “bookmark device”, “smart device”, and “device” are interchangeable and refer to the smart bookmark device 100 of the present invention.

Notwithstanding the forgoing, the smart bookmark device 100 of the present invention can be of any suitable size and configuration as is known in the art without affecting the overall concept of the invention, provided that it accomplishes the above stated objectives. One of ordinary skill in the art will appreciate that the smart bookmark device 100 as shown in FIGS. 1-6 is for illustrative purposes only, and that many other sizes and shapes of the smart bookmark device 100 are well within the scope of the present disclosure. Although the dimensions of the smart bookmark device 100 are important design parameters for user convenience, the smart bookmark device 100 may be of any size that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A smart bookmark device that provides a user with a bookmark with smart capabilities, the smart bookmark device comprising:
a housing component;
wherein the housing component comprises a processor, a memory, and an input/output component;
wherein the housing component enables a user to scan, use verbal commands, or manually input information about a certain text; and
further wherein the processor, the memory, and the input/output component process the information being scanned or entered by the housing component.

2. The smart bookmark device of claim 1, wherein the housing is configured in an elongated rectangular shape.

3. The smart bookmark device of claim 2, wherein the housing component comprises a front surface, a bottom surface, opposing top and bottom ends, and opposing right and left sides.

4. The smart bookmark device of claim 3, wherein the housing component includes a display module with a display screen, positioned on the front surface and an on/off button.

5. The smart bookmark device of claim 4, wherein the memory is large enough to store data, such as text data, highlighted notes, personal information, etymology information, legal dictionaries, medical dictionaries, and academic curriculums.

6. The smart bookmark device of claim 5, wherein the processor utilizes Artificial Intelligence (AI) to help process information when scanned by the smart bookmark device, wherein the AI communicates with the processor, memory and input/output components to process information and output definitions and other requested information.

7. The smart bookmark device of claim 6 further comprising a wireless communication module and additional sensors which would allow the smart bookmark device to communicate with the internet or outside databases of information when performing functionalities.

8. The smart bookmark device of claim 7, wherein the housing component comprises a USB port.

9. The smart bookmark device of claim 8, wherein the processor, the display screen, the memory, the input/output component, and other electrically-powered components of the smart bookmark device can be powered by a battery.

10. The smart bookmark device of claim 8, wherein the processor, the display screen, the memory, the input/output component, and other electrically-powered components of the smart bookmark device can be powered by a solar panel.

11. The smart bookmark device of claim 8, wherein the housing component comprises a wedge shape on the opposing left side to fit into a spine of a book.

12. The smart bookmark device of claim 11, wherein the display screen is a touchscreen.

13. The smart bookmark device of claim 12, wherein the housing component includes a stylus.

14. A smart bookmark device that provides a user with a bookmark with smart capabilities, the smart bookmark device comprising:
a housing component comprising a front surface, a bottom surface, opposing top and bottom ends, and opposing right and left sides;
wherein the housing component includes a display module with a display screen, positioned on the front surface and an on/off button;
wherein the housing component comprises a wedge shape on the opposing left side to fit into a spine of a book;
wherein the display screen is a touchscreen and includes a stylus;
wherein the housing component comprises a processor, a memory, and an input/output component;
wherein the housing component enables a user to scan, use verbal commands, or manually input information about a certain text;
wherein the processor utilizes Artificial Intelligence (AI) to help process information when scanned by the smart bookmark device, wherein the AI communicates with the processor, memory and input/output components to process information and output definitions and other requested information scanned by the housing component; and
further wherein the housing component includes a wireless communication module and additional sensors which would allow the smart bookmark device to communicate with the internet or outside databases of information when performing functionalities.

15. The smart bookmark device of claim 14 further comprising an internal digital calculator.

16. The smart bookmark device of claim 14 further comprising a soundproof wireless microphone.

17. The smart bookmark device of claim 14 further comprising a speaker.

18. The smart bookmark device of claim 14, wherein the smart bookmark device is powered by a battery or a solar panel.

19. The smart bookmark device of claim 14 further comprising a plurality of indicia.

20. A method of assisting readers while reading a book, the method comprising the following steps:
providing a smart bookmark device comprising a housing component with a microphone, a digital calculator, a touchscreen and a stylus;
utilizing AI and etymology functions to scan text and lookup information;
receiving information via voice commands on the microphone;
utilizing the digital calculator when numbers or equations are scanned; and
highlighting information via the touchscreen and stylus to save as notes.
